(19) United States
(12) Patent Application Publication
(10) Pub. No.: US 2002/0197976 A1
(43) Pub. Date: Dec. 26, 2002

(54) Vehicle customized feature activation system

(76) Inventors: Jonathan Liu, Cupertino, CA (US); Constance Liu, Cupertino, CA (US)

Correspondence Address: Richard C Liu, 20397 Via Napoli, Cupertino, CA, 95014, US

(21) Appl. No.: 09/976,544

(22) Filed: Oct. 15, 2001

Related U.S. Application Data
(63) Continuation-in-part of application No. 09/886,189, filed on Jun. 22, 2001.

(51) Int. Cl. H04B 1/06

(52) U.S. Cl. 455/352; 455/353

(57) ABSTRACT

Briefly, this invention allows multiple users to activate their preferred settings for the various customizable features in a vehicle. These preferred settings are stored in memory for subsequent use. One of a multiple drivers to a vehicle, after being identified, will cause his previously stored preferred settings in the memory to be applied to the appropriate subsystems in the vehicle. The preferred settings include driver and companion seat positioning, front and rear temperature control, radio station and speaker adjustment selections, steering wheel positioning and door lock and unlock specification.

Advantageously, the present invention reduces confusion and adds comfort to the drivers of the same vehicle in that when a driver returns to a multi-driver vehicle, the preferred settings that she had last saved while in the vehicle will be applied to the appropriate vehicle subsystems. It is as if this driver is the only driver of the vehicle.

### CROSS-REFERENCE TO RELATED APPLICATION

This application is a continuation-in-part (CIP) application of the co-pending U.S. patent application Ser. No. 09/886,189 filed Jun. 22, 2001 on the behalf of Constance Liu et al., entitled “RADIO THAT REMEMBER ADJUSTMENT SETTINGS”.

### FIELD OF THE INVENTION

This invention has to do in general with a vehicle customized feature activation system. This system is most useful in a multi-driver environment. In particular, this invention has to do with a vehicle feature activation system dependent upon driver identification. A part of this system includes a radio to be operated inside a vehicle. An aspect of the invention relates to such a radio system that automatically makes available for selection pre-set frequencies of radio stations for each of the multiple drivers to the vehicle. As an example, for each driver in this multiple-driver environment, this invention relates to a radio system that once the radio is turned on, it defaults to the last-played radio station for that driver. Another aspect of the invention relates to such a radio system that automatically makes available a preferred combination of radio speaker adjustments such as volume, bass and treble for each of the multiple drivers to the vehicle. As a practical advantage, this invention adds comfort to and reduces confusion resulting from the use of a car by more than one driver.

### BACKGROUND INFORMATION

A vehicle such as a car has many features that are customizable depending on user preferences, e.g., seat positioning, temperature control and radio adjustment selection. A disadvantage of the vehicle having many customizable features, however, rises when more than one person uses the same features but with different preferred settings.

For example, radio is commonplace inside a vehicle. Once a radio station is tuned to, a typical car radio has multiple adjustment mechanisms (e.g., via dials and/or push knobs) to allow a user (usually a driver of the car) to preferably set volume, bass, treble, speaker location and the like. The disadvantage occurs when more than one driver uses the same car radio. In the case of a “family car” where parents and young adults in the family share a car, the radio station adjustment preferences for each of the drivers to this car may be drastically different. In other words, a young adult may prefer ‘loud’ volume, heavy ‘bass’ and speakers ON only in the front; whereas the parent may prefer ‘soft’ volume, balanced ‘bass’ and ‘treble’ and speakers ON for the front and the rear. In short, the more drivers there are to this “family car”, the more difficult it becomes for each driver to fully enjoy the comfort this radio because the number of adjustments required every time one turns on the radio of this ‘family car’.

The difficulty of a multi-user or multi-driver environment is further compounded by the different preferred settings for the additional customizable features such as seat and mirror positioning, temperature control and steering wheel positioning.

Therefore, it is desirable to have a system that allows each of the multiple users to automatically store and re-use his or her preferred settings for the many customizable features in a vehicle.

### SUMMARY OF THE INVENTION

Briefly, an apparatus and method are provided for allowing multiple users to activate their preferred settings for the various customizable features in a vehicle. These preferred settings are stored in memory for subsequent use. One of the multiple drivers to the vehicle, after being identified, will cause his previously stored preferred settings in the memory to be applied to the appropriate subsystems in the vehicle. The preferred settings include driver and companion seat positioning, front and rear temperature control, radio station and speaker adjustment selections, steering wheel positioning and door lock and unlock specification.

For a multi-driver vehicle, an identification system in the vehicle first uniquely identifies the driver entering the vehicle. The identification process may be accomplished by a number of ways including a remote-controlled transmission, a key insertion or even a His/Her switch located inside the vehicle. After the driver is identified, his preferred settings previously stored in the memory will be accessed and applied to the appropriate subsystems in the vehicle. Each driver in this multi-driver vehicle is likely to have a set of preferred settings stored in the memory different from that of another, but each set is made available to be used by the vehicle once the ‘owner’ of that set is identified to have entered the vehicle.

Advantageously, the present invention reduces confusion and adds comfort to the drivers of the same vehicle in that when a driver returns to a multi-driver vehicle, the preferred settings that he had last saved while in the vehicle will be applied to the appropriate vehicle subsystems, whatever they may be. It is as if this driver is the only driver of the vehicle.

### BRIEF DESCRIPTION OF THE DRAWINGS

A better understanding of the present invention can be obtained by considering the following detailed description taken together with the accompanying drawings that illustrate preferred embodiments of the present invention in which:

FIG. 1 shows a simplified functional diagram of the present invention including a vehicle micro-controller in accordance with the present invention.

FIG. 2 shows a typical appearance of a car radio; and

FIG. 3 shows a simplified functional diagram of a part of the present invention directed to a radio subsystem.

### DETAILED DESCRIPTION OF THE PREFERRED EMBODIMENTS

With today's advances in technology, the design of specialized integrated circuits and programmable logic generally do not require the rendering of fully detailed circuit diagrams. The definition of logic functionality allows computer design techniques to design the desired logic and circuits. Additionally, vehicle micro-controllers are known to operate based on a desired flow chart diagram rendered into software. Accordingly, portions of the present invention will be described primarily in terms of functionality to be implemented by a vehicle micro-controller and other associated electronic components. This functionality will be described in detail with the associated flow chart diagram. Those of ordinary skill in the art, once given the following descriptions of the various functions to be carried out by the present invention will be able to implement the necessary micro-controller structure and logic for various logic devices or custom designed integrated circuits in suitable technologies without undue experimentation.

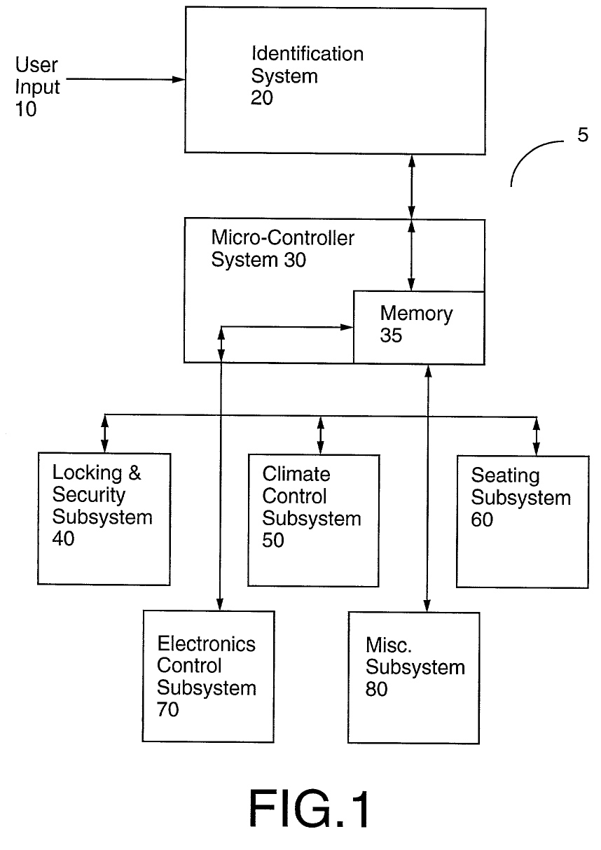

FIG. 1 shows a simplified functional diagram of the present invention 5 including a vehicle micro-controller system 30 in which there is memory 35. The invention 5 includes an identification subsystem 20, a locking & security subsystem 40, a climate control subsystem 50, a seating control subsystem 60, an electronics control subsystem 70 and miscellaneous control subsystem 80. Any of the subsystems 20,40,50,60,70,80 may include memories, and each of the subsystems 20,40,50,60,70,80 is individually coupled to the vehicle micro-controller 30. User input 10 is received and processed by the identification subsystem 20 for user identification. These subsystems are commonplace in today's vehicles; however, their combination as disclosed by the present invention is not.

As a preferred embodiment for the user input 10 and identification subsystem 20 for a vehicle, a remote device (e.g., a keyless entry system) may be used for activating customized vehicle features including locking and unlocking vehicle doors. Transmissions that each is uniquely-coded may be generated by this typical device to distinguish one user from another. The transmissions, either electronic, infrared, ultrasound or otherwise are the preferred user input 10, and the transmission receiving system is preferably the identification subsystem 20. A car may have associated with it several such remote devices one for each driver of the car, and each device generates a unique transmission for identification purposes. Alternatively, a remote device may have more than one button where each button controls the generation of one unique transmission. In other words, one driver may use button X on a remote device and another driver may use button Y on another remote device to distinguish driver identity one from another.

The identification subsystem 20 may further be a His/Her toggle switch and related circuitry found in many cars where a toggle (user input 10) in “His” direction identifies one driver and a toggle in “Her” direction identifies another driver. Such identification may be used subsequently and automatically for seating, radio preferences and climate control in different portions of the vehicle internal compartment. Even with keys, differing notch-and-groove key patterns may be used to lock and unlock the same lock but each key pattern when inserted may be sensed to enable the present invention to distinguish one user from another. In the newer car models, biometrics such as voice or even fingerprint may be used for driver identification.

The information of the driver identity is then transmitted from the identification subsystem 20 to the memory 35 of the micro-controller system 30. This identity information is then made to associate with in the memory 35 the various customized settings of climate control, seating, electronics control and locking/unlocking preferences that were stored by the same driver previously. The association process does not have to occur in the memory 35 of the micro-controller system 30, it may happen alternatively in each of the respective subsystems 20,40,50,60, 70,80. Regardless, once the preferences for the identified driver are located, each of the preferences associated with the driver is fed to the appropriate subsystems 40,50,60,70,80 for automatic execution. For example, air condition may now be set at a different temperature from before, motorized seating subsystem may now be arranged into a new position, a different set of radio adjustment preferences is now available and only the front doors will unlock instead of all doors. Some features may respond to the user input 10 automatically such as the seating position arrangement whereas others may be effected after the subsystems are subsequently turned ON such as in the case of radio or air conditioner.

The subsystems 40,50,60,70,80 may include typical vehicle features. For instance, the locking & security subsystem 40 may include preferences for the locking and unlocking doors, sunroof, opening and closing of windows and activation and deactivation of features such as garage door control and antitheft system. The climate control subsystem 50 may include preferences for temperature and humidity control. The seating subsystem 60 may include preferences for seating positions for the driver and the companion and the heating levels for the seats. The electronics control subsystem 70 may include preferences for radio adjustments, navigational map features, cruise control and CD player. The miscellaneous control subsystem 80 may include preferences for vehicle exterior features such as lamp controls or interior features such as steering wheel positioning and mirror positioning.

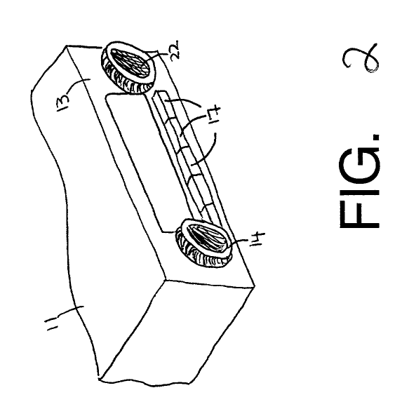

Since each of the referred to subsystem features is known in the art, further elaboration on the mechanism is not needed; however, as an illustration to the skilled artisans on how a typical subsystem interacts with its micro-controller, a description of a radio system of the electronics control subsystem 70 of the present invention is provided. Please now refer to FIG. 2. This FIG. 2 shows a typical appearance of a car radio 11. An ON/OFF and a sound volume selection features are usually accomplished by the use of a knob 14. Sometimes additional features such as left/right speaker volume and bass/treble range adjustments may be activated by first pulling outward or pushing inward the knob 14. A desired radio station tuning frequency may be selected by the use of another knob 22. Typically, on a face 13 of the car radio 11, there are several mechanical push buttons 17. Each of these mechanical push buttons 17 is used to store and to select the tuning frequency of a preferred radio station. In short, after storing the frequency of a preferred radio station using one of the mechanical push buttons 17, a driver may subsequently cause the radio to tune to that previously stored radio station frequency by depressing that particular mechanical push button 17. The mechanism and method for such storage and selection are well known, and the details of which will not be elaborated here. A preferred embodiment of the present invention may take on the outside appearance of this typical car radio 11. Functionally speaking, however, each of the mechanical push buttons 17 of the present invention may be used to store and to select instead of one, but more than one station tuning frequency depending on the identity of the user.

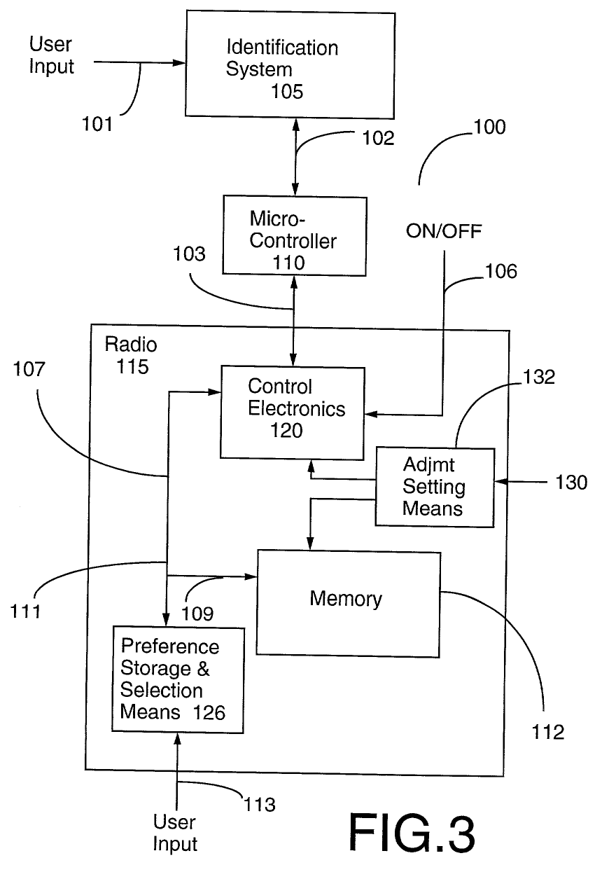

Referring now to FIG. 3, it shows a simplified functional diagram of a radio system 100 including a vehicle micro-controller 110 in accordance with the present invention. The radio system 100 includes an identification system 105, the vehicle micro-controller 110 and a radio 115. The micro-controller 110 is coupled with the identification system 105 via path 102 and couples to the radio 115 via path 103. User input is received by the identification system 105 via path 101, and user input is also received by the radio 115 via paths 106 and 113. The user input and the identification system 105 are the same as the user input 10 and the identification subsystem 20 of FIG. 1, and they will not be further elaborated here. However, the preferred embodiment as illustrated by FIG. 3 includes its memory inside the radio 115 instead of in the micro-controller system 30 (FIG. 1).

The information of the driver identity is transmitted from the identification system 105 to the micro-controller 110 via path 102 whereby making the information available for use by the radio 115 via path 103. The radio 115 includes control electronics 120, preference storage and selection means 126, adjustment setting means 132 and memory 112. The driver identification information will be used by the radio 115 depending on the ON/OFF input via path 106 to the control electronics 120 of the radio 115. For example, if a user turns the knob 14 of FIG. 2 OFF, then the radio 115 would not process the driver identification information although such information is available in the identification system 105.

The preference storage and selection means 126 in a preferred embodiment includes half a dozen or so mechanical push buttons disposed on a face of the radio 115 similar to the prior art buttons 17 in FIG. 2. The radio station preference information as user input is stored into the memory 112 via paths 111, 109 for subsequent selection under the control of the control electronics 120 via paths 111, 107.

The adjustment setting means 132 in a preferred embodiment includes the typical knobs (e.g., reference 14 of FIG. 2), dials or other user input devices 130 where preferred radio adjustment settings for volume (of each speaker or all speakers), bass, treble and the like for a user are entered and stored in the radio memory 112. Such stored adjustment setting information is associated with the driver identification information of the user in the memory 112 so that the settings that were last used before the turn off of the radio will be applied by the control electronics 120 to the speaker output once the same user is identified the next time he turns on the radio 115.

When the radio 115 is ON, a driver may provide user input via path 113 to either store or select preferred radio station frequencies using methods well known in the art. Since the current driver identity is received by the radio 115 from the identification system 105, the preference storage and selection information actuated by using the preference means 126 via path 113 is then associated with the current driver identity in the memory 112. For instance, a driver A saves a radio station frequency B through the preference means 126 (e.g., depressing a mechanical push button C for a few seconds while the station is being tuned to). The control electronics 120 will then process the information and will then preferably via firmware and in memory 112 link the radio station frequency B to the mechanical button C and the current driver identity received from the identification system 105. Subsequently, to select and tune to the previously-saved radio station B, the driver A after having been identified by the identification system 105, will actuate the preference means 126 (e.g., depressing briefly the mechanical push button C). The control electronics 120 will then retrieve from memory 112 the radio station frequency B that is linked to the matching current driver identity and the mechanical push button C and will then proceed to tune to the radio station frequency B.

As a result, the driver A storing or selecting a radio station frequency using a particular mechanical button of the preference means 126 is distinguishable from a driver D storing or selecting another radio station frequency using the same particular mechanical button. In other words, the driver A operates the preference means 126 as if he is the only driver to the car and the same is true for driver D.

The foregoing description of preferred embodiments of the present invention have been presented for purposes of illustration and description. They are not intended to be exhaustive or to limit the invention to the precise forms disclosed, and obviously many modifications and variations are possible in light of the above teaching. It is intended that the scope of the invention be defined by the claims appended hereto and their equivalents.

We claim:

1. A customized feature activation system in a vehicle for allowing each of a plurality of drivers to activate personal preference settings for a plurality of vehicle subsystems, said activation system comprising:
an identification system including a plurality of remote devices of a keyless entry system for the vehicle wherein each remote device being capable of generating a uniquely-coded transmission for generating a first current driver identity;
a vehicle micro-controller located in the vehicle and said vehicle micro-controller being operatively coupled to the identification system for receiving the first current driver identity;
the vehicle micro-controller having memory for storing the first current driver identity and for associating the first current identity with preferred settings for a first vehicle subsystem previously stored in the memory;
the first vehicle subsystem operatively coupled to the vehicle micro-controller to receive and process the preferred settings for the first vehicle subsystem;
a second vehicle subsystem including a radio that including preference means for receiving preferred station information for storage, memory for storing the preferred station information for storage, and control electronics for preferred station information processing and for receiving the first current driver identity from the vehicle micro-controller and linking in the memory the first current driver identity to the preferred station information for storage;
the preference means further receiving preferred station information for selection and tuning and the control electronics being operatively configured to receive a second current driver identity from the identification system and further being configured to respond to the preferred station information for selection and tuning by selecting and tuning to the preferred station information for storage whose linked first current driver identity matching with the second current driver identity;
the radio of the second vehicle subsystem further including adjustment setting means for allowing user adjustment preferences to be applied to speaker output of the radio via the control electronics, the user adjustment preferences being stored and linked with the first current driver identity in the memory; and
the control electronics being configured to apply to the speaker output the user adjustment preferences whose linked first current driver identity matching with the second current driver identity.

2. The activation system as claimed in claim 1 wherein the user adjustment preferences include a volume adjustment, a treble adjustment and a bass adjustment.

3. The activation system as claimed in claim 1 wherein the first vehicle subsystem includes a climate control subsystem.

4. The activation system as claimed in claim 1 wherein the first vehicle subsystem includes a seating subsystem.

5. The activation system as claimed in claim 1 wherein the first vehicle subsystem includes a locking & security subsystem.

6. The activation system as claimed in claim 1 wherein the second vehicle subsystem includes an electronics control subsystem.

7. A method for activating multi-user customized features in a vehicle, said activating step comprising:
generating and outputting a current driver identity by an identification system, said identification system including at least one remote device of a keyless entry system for the vehicle wherein the at least one remote device being capable of generating a uniquely-coded transmission for generating the current driver identity;
receiving the current driver identity by a vehicle micro-controller located in the vehicle and said vehicle micro-controller being operatively coupled to the identification system, the vehicle micro-controller further having memory for storing the current driver identity and for associating the current driver identity with preferred settings for a first vehicle subsystem and for a second vehicle subsystem previously stored in the memory;
receiving and processing the preferred settings for the first vehicle subsystem by the first vehicle subsystem, said first vehicle subsystem being operatively coupled to the micro-controller; and
receiving and processing the preferred settings for the second vehicle subsystem by the second vehicle subsystem, said second vehicle subsystem being operatively coupled to the micro-controller.

8. The activating method as claimed in claim 7 wherein the first vehicle subsystem includes a locking & security subsystem.

9. The activating method as claimed in claim 8 wherein the second vehicle subsystem includes a climate control subsystem.

10. The activating method as claimed in claim 8 wherein the second vehicle subsystem includes a seating subsystem.

11. The activating method as claimed in claim 8 wherein the second vehicle subsystem includes an electronics control subsystem.

12. The activating method as claimed in claim 8 wherein the second vehicle subsystem includes a miscellaneous subsystem.

13. A multi-user customized feature activation system comprising:
an identification system for generating a current driver identity;
a vehicle micro-controller located in the vehicle and said vehicle micro-controller being operatively coupled to the identification system for receiving the current driver identity, the vehicle micro-controller further having memory for storing the current driver identity and for associating the current driver identity with preferred settings for a locking & security vehicle subsystem, a climate control subsystem, a seating subsystem, an electronics control subsystem and a miscellaneous subsystem previously stored in the memory;
the locking & security vehicle subsystem operatively coupled to the vehicle micro-controller to receive and process the preferred settings for the locking & security vehicle subsystem;
the climate control vehicle subsystem operatively coupled to the vehicle micro-controller to receive and process the preferred settings for the climate control vehicle subsystem;
the seating vehicle subsystem operatively coupled to the vehicle micro-controller to receive and process the preferred settings for the seating vehicle subsystem;
the electronics control vehicle subsystem operatively coupled to the vehicle micro-controller to receive and process the preferred settings for the electronics control vehicle subsystem; and
the miscellaneous vehicle subsystem operatively coupled to the vehicle micro-controller to receive and process the preferred settings for the miscellaneous vehicle subsystem.

14. The activation system as claimed in claim 13 wherein the preferred settings for the locking & security subsystem include the number of doors to unlock and lock.

15. The activation system as claimed in claim 13 wherein the preferred settings for the climate control subsystem include the temperature to maintain inside the vehicle.

16. The activation system as claimed in claim 13 wherein the preferred settings for the electronics control subsystem include the radio speaker adjustments.

17. The activation system as claimed in claim 13 wherein the preferred settings for the miscellaneous subsystem include the preferred vehicle steering wheel position.
